(19) United States
(12) Patent Application Publication
(10) Pub. No.: US 2006/0170786 A1
(43) Pub. Date: Aug. 3, 2006

(54) Digital camera and method

(76) Inventor: Nara Won, Allen, TX (US)

Correspondence Address: TEXAS INSTRUMENTS INCORPORATED, P O BOX 655474, M/S 3999, DALLAS, TX, 75265, US

(21) Appl. No.: 11/048,270

(22) Filed: Jan. 31, 2005

(51) Int. Cl. H04N 5/228

(52) U.S. Cl. 348/222.1

(57) ABSTRACT

A digital camera with programmable raw data compressor/decompressor provides an alternative path for output from an image sensor to external memory and then to an image processing pipeline. The compression may be lossless and reduce the required external memory size to contain a burst of shots prior to image processing.

### CROSS-REFERENCE TO RELATED APPLICATIONS

The following coassigned pending patent applications disclose related subject matter: application Ser. No. ______, filed ______.

### BACKGROUND OF THE INVENTION

The present invention relates to electronic devices, and more particularly to image capture methods and related devices such as digital cameras.

Recently, digital cameras have become a very popular consumer appliance appealing to a wide variety of users ranging from photo hobbyists, web developers, real estate agents, insurance adjusters, photo-journalists to everyday photography enthusiasts. Advances in large resolution CCD/CMOS sensors coupled with the availability of low-power digital signal processors (DSPs) has led to the development of digital cameras with both high resolution image and short video clip capabilities, and these capabilities have spread into various consumer products such as cellular phones. The high resolution (e.g., sensor with a 2560×1920 pixel array) provides quality offered by traditional film cameras. U.S. Pat. No. 5,528,293 and U.S. Pat. No. 5,412,425 disclose aspects of digital camera systems including storage of images on memory cards and power conservation for battery-powered cameras.

FIG. 3a is a functional block diagram for digital camera control and image processing; the automatic focus, automatic exposure, and automatic white balancing are referred to as the 3A functions. The image processing typically includes functions such as color filter array (CFA) interpolation, gamma correction, white balancing, color space conversion, and JPEG/MPEG compression/decompression (JPEG for single images and MPEG for video clips) and is referred to as the image pipeline. Note that the typical color CCD consists of a rectangular array of photosites (pixels) with each photosite covered by a filter (the CFA): typically, red, green, or blue. In the commonly-used Bayer pattern CFA one-half of the photosites are green, one-quarter are red, and one-quarter are blue. FIG. 3b illustrates possible hardware components for a digital camera.

The current trends of incorporating video capabilities plus higher resolution require increasingly large short-term storage to hold raw image data prior to image processing. For example, a burst of 10 shots from a 5 megapixel CCD with 2 bytes/pixel would require 100 megabytes of memory to hold the raw image data prior to image processing. Thus there is a problem of memory capacity for digital camera performance.

### SUMMARY OF THE INVENTION

The present invention provides devices and methods for programmable compression of raw image data for temporary storage prior to image processing pipeline.

This has advantages including higher camera performance.

### BRIEF DESCRIPTION OF THE DRAWINGS

The drawings are heuristic for clarity.

FIGS. 1a-1b are block diagrams of preferred embodiment digital camera front ends.

FIGS. 2a-2b illustrate compression options.

FIGS. 3a-3b show functional and hardware blocks of of a digital camera.

### DESCRIPTION OF THE PREFERRED EMBODIMENTS

### 1. Overview

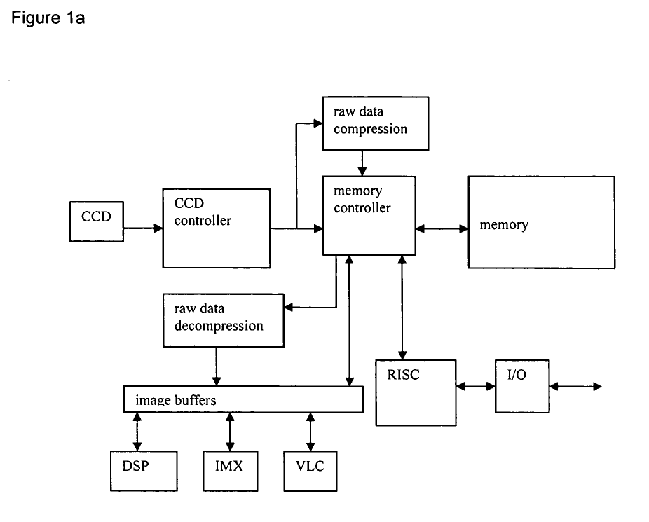

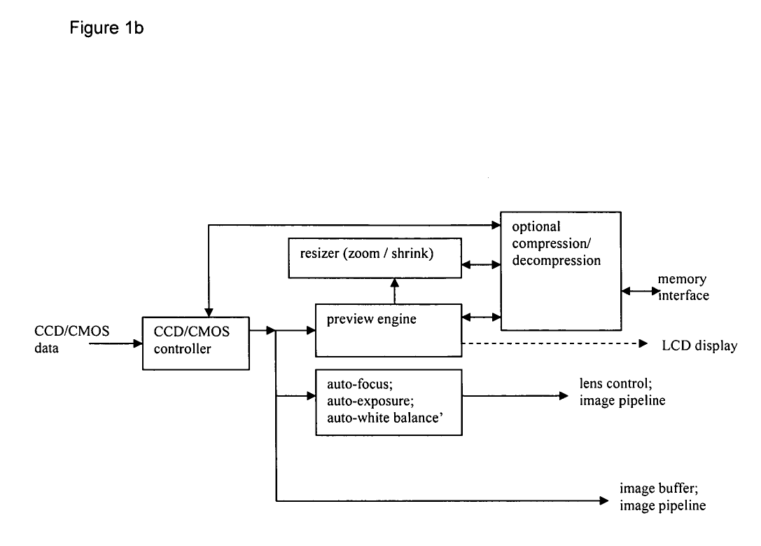

Preferred embodiment digital cameras have a compressor and decompressor to provide for raw sensor data to be stored more compactly prior to image processing; this allows for reduced memory size to contain a raw sensor data. FIG. 1a illustrates processing blocks for a camera with the compressor receiving input directly from the sensor controller and the decompressor output directly to an image buffer. The compression method used could be lossless (e.g., run length encoding) or lossy if image quality degradation can be tolerated (e.g., ADPCM).

Preferred embodiment camera systems and devices, such as digital still cameras and video-capable cellular phones, include preferred embodiment compression/decompression. The compression and decompression computations can be performed with application specific circuitry, or possibly with a programmable processor, and be part of a system on a chip. The compression parameters may be programmed (ROM, Flash EEPROM, FeRAM, etc.) and read to registers to adapt to the external memory used in the camera system. Analog-to-digital converters and digital-to-analog converters provide coupling to the real world, and modulators and demodulators (plus antennas for air interfaces) provide coupling for wireless transmission.

### 2. Preferred Embodiments

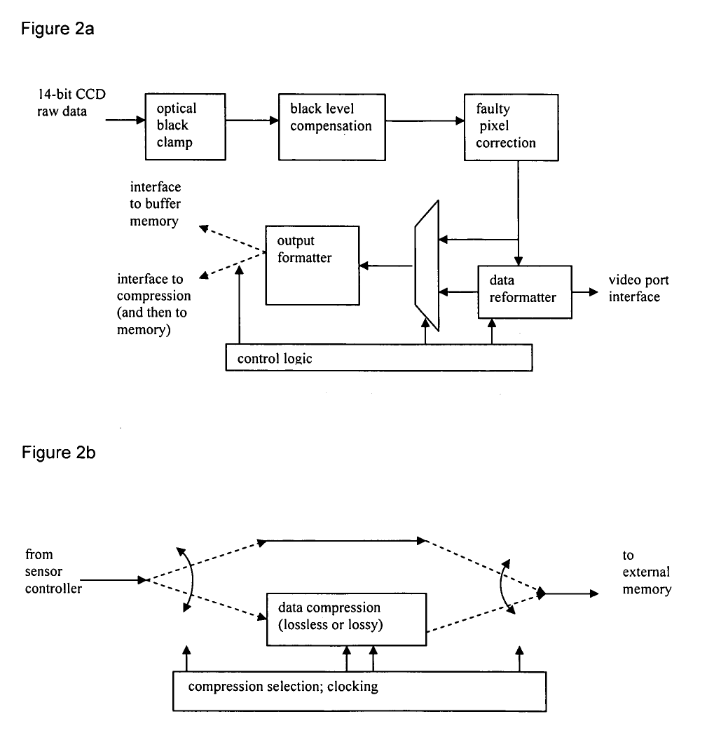

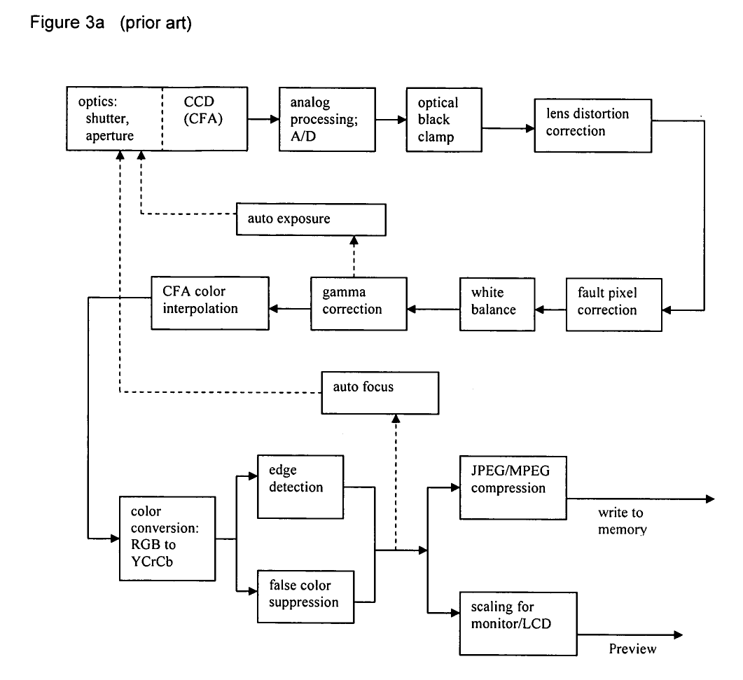

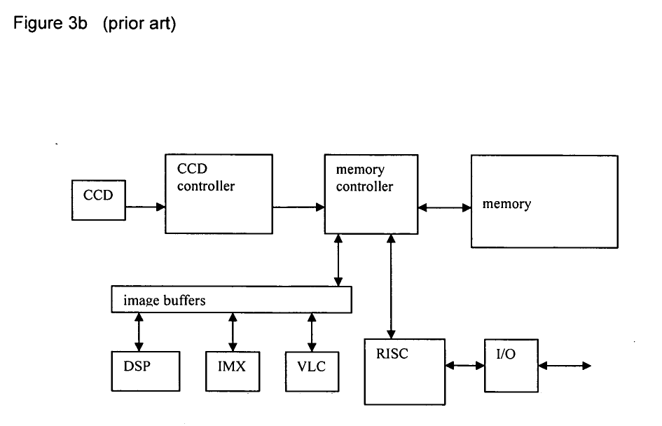

FIG. 2a shows data flow in a CCD/CMOS controller for a preferred embodiment digital camera. The CCD/CMOS controller accepts raw image/video data from an external CCD/CMOS sensor (upper left in FIG. 2a) and outputs the data to one of an external memory (SDRAM/DDRAM) interface, a data compression (and then external memory), or video processing front end modules, such as a preview engine, 3A (auto-focus, auto-exposure, auto-white balance) functions, image statistical data analysis functions, or image resizing functions. The main processing done by the controller on the raw data is optical black clamping and then a fault pixel correction. Following the fault pixel correction, the data can be routed to external memory, to data compression (and then to external memory), or to the processing modules. In the case of the data sink being either the external memory or the compression (and then external memory), the data is packed appropriately and culled; see the lower left portion of FIG. 2a.

FIG. 2a shows the compressor following faulty pixel correction and prior to memory write or video-mode processing; however, the compressor may be at other locations in the processing, such as between the optical black clamp and the faulty pixel correction; however, the decompression from external memory would then output to the faulty pixel correction. Note that in order to optimize the dynamic range of the pixel values represented by the image sensor, the pixels representing black should have a 0 value. The black clamp function adjusts for this by subtracting an offset for each pixel. There is only one color channel per pixel at this stage of the processing.

Image sensor arrays may have faulty (missing) pixels, especially large arrays. The missing pixel values are filled by simple interpolation within the array; a high order interpolation may not be necessary because a later interpolation is also performed in the CFA interpolation stage. Therefore, the main reason for this preliminary faulty pixel correction interpolation step is to make the image processing regular by eliminating missing data. Again, the faulty pixel correction may precede or follow a compression plus write to memory and read from plus decompression.

The compression may be programmable as illustrated by FIG. 2b. Various standard data compression algorithms may be implemented. For high resolution images, a lossless compression would be chosen, such as run length encoding, dictionary encoding (e.g., variations of the Lempel-Ziv-Welch algorithm), entropy encoding (e.g., adaptive Huffman coding), Burrows-Wheeler transform (e.g., Bzip2), and so forth. If the compression ratio of lossless data is 5:1, then the background example of a burst of 10 shots from a 5 megapixel sensor with 2 bytes/pixel could have its memory requirement reduced from 100 megabytes to 20 megabytes.

Alternatively, the compression could be lossy; this permits a lower cost camera for operations such as a burst of shots by trading off lower resolution for reduced memory size. That is, for normal operation use the lossless compression (or no compression), but for a burst, select lossy compression in order to have all of the shots fit in the (small) external memory. In the background example of 10 shots from a 5 megapixel sensor with 2 bytes/pixel, a 20:1 compression ratio would reduce the memory required from 100 megabytes to 5 megabytes. The lossy compression could be ADPCM, wavelet, JPEG (raw data treated as a luminance frame), and so forth. Additionally, the quantization level in the lossy compression could be programmable and adapt to memory size or shot capacity.

Typically, a CCD/CMOS sensor outputs a pixel (e.g., 10 or 14 bits) onto a bus of at least pixel width once each pixel clock cycle. For example, with the pixel clock running at 10 MHz, a 5 megapixel sensor will take about 500 ms to readout. Thus bursts of shots could include up to 2 shots per second. And the 10 MHz pixel clock would also require the FIG. 2a pixel processing in the CCD/CMOS controller (or each stage, if pipelined) to be performed within 100 ns. Likewise the pixel write to external memory or the pixel compression (or each stage, if pipelined) also must be performed on average within 100 ns. Note that a compression such as JPEG uses a block transform, and the transform cannot be performed until the pixels constituting the block have been read; thus the compressor requires a (small) buffer and the pixel clock only constrains the average time per pixel for the compression.

FIG. 1a illustrates both the compressor with input from the CCD/CMOS controller and with output to the external memory and the decompressor with input from the external memory and output to the image buffer. If raw data in the external memory had not been compressed, then the readout from the external memory is directly to the image buffer; whereas, if the data had been compressed prior to storage in the external memory, then the data readout is from the external memory to the decompressor and after decompressed to the image buffer. Like the compressor, the decompressor also is preferably a specialized circuit, although the pixel clock timing constraints do not apply.

FIG. 1b shows another preferred embodiment with explicit modules including a preview engine (a simplified image pipeline for camera user preview prior to taking a shot), a resizer (upsampling for digital zoom and downsampling), and the 3A functions. The preview engine output can be sent to an LCD display for viewing by the camera user; this is indicated by a broken arrow in FIG. 1b because the LCD drivers may read the preview engine output data from the external memory. The outputs of both the preview engine and the resizer can be compressed prior to storage in external memory, and decompressed upon readout.

A compressor module will have an output register which contains the compressed raw data size and also have a register which contains the start address of memory to save compressed data.

A decompressor module will have an input register which receives the compressed raw data size and also have a register which receives the start address of memory to read compressed data.

### 3. Modifications

The preferred embodiments may be varied while retaining one or more of the feature of a compression of raw data from a sensor array in a digital camera for temporary storage prior to image pipeline processing.

For example, the compression ratio can be increased by applying motion compensation which is used in MPEG or M-JPEG for sequential images in a burst shot because images in a burst shot will have behavior very similar to a movie. To implement this, motion vectors should be calculated between successive images. Another example is a next start address to save/read compressed data can be calculated automatically by a compressor/-decompressor module.

What is claimed is:

1. A digital camera, comprising:
(a) an image sensing unit;
(b) a memory controller coupled to said image sensing unit;
(c) an image processing pipeline coupled to said memory controller;
(d) a data compressor coupled between said image sensing unit and said memory controller; and
(e) a data decompressor coupled between said memory controller and said image processing pipeline.

2. The camera of claim 1, wherein:
(a) said data compressor provides lossless compression.

3. The camera of claim 2, wherein:
(a) said lossless compression is a dictionary compression.

4. The camera of claim 1, wherein:
(a) said image sensing unit includes a CCD and a CCD controller; and
(b) said image processing pipeline is implemented with a programmable digital signal processor.

5. A digital camera method, comprising:
(a) compressing raw image data;
(b) storing said compressed raw image data;
(c) after step (b) reading said compressed raw image data from storage;
(d) decompressing said compressed raw image data to yield decompressed image data; and
(e) applying said decompressed image data to an image processing pipeline.

6. The method of claim 5, wherein:
(a) said compressing of step (a) of claim 1 is lossless compression.
